(19) United States
(12) Patent Application Publication
(10) Pub. No.: US 2020/0104384 A1
(43) Pub. Date: Apr. 2, 2020

(54) SYSTEMS AND METHODS FOR CONTINUOUS TRIM COMMANDS FOR MEMORY SYSTEMS

(71) Applicant: Nutanix, Inc., San Jose, CA (US)

(72) Inventors: David Knierim, Durham, NC (US); Aman Nijhawan, San Jose, CA (US); Brad Kintner, Chapel Hill, NC (US); Pete Wyckoff, San Jose, CA (US)

(73) Assignee: Nutanix, Inc., San Jose, CA (US)

(21) Appl. No.: 16/150,205

(22) Filed: Oct. 2, 2018

(51) Int. Cl. G06F 17/30; G06F 12/02; G06F 3/06

(52) U.S. Cl. CPC G06F 17/30138; G06F 12/0253; G06F 3/0652; G06F 2212/7205; G06F 3/061; G06F 3/0638; G06F 2212/7201; G06F 3/0679

(57) ABSTRACT

Systems and methods for issuing continuous trim commands for a memory system, including periodically sending trim commands to an electronically erasable memory device. Each of the trim commands identifies unused blocks of a portion of a total storage capacity of the electronically erasable memory device to erase.

### BACKGROUND

The following description is provided to assist the understanding of the reader. None of the information provided or references cited is admitted to be prior art.

Hard disk drives are configured to write new data over existing data that was previously written, and therefore do not require the existing data to be erased before writing the new data. Therefore, file systems coupled to the hard disk drives do not need to have knowledge of if or when data has been erased from the hard disk drives. Electronically erasable memory systems (e.g., flash memory systems such as but not limited to, Solid State Drives (SSDs)) behave differently from hard disk drives. As used to herein, SSDs refer to SSD devices that implement flash memory technology. For example, SSDs store data in physical locations referred to as flash cells. Before writing to a flash cell, previously written data in the flash cell needs to be erased or otherwise cleaned. To improve SSD performance, commands such as but not limited to the Advanced Technology Attachment (ATA) trim command and the Small Computer System Interface (SCSI) unmap command have been created to provide a method by which the file systems can inform the SSDs of the blocks that are no longer in use, so that the SSDs can erase that block in the background. It has been observed that sending a large number of trim commands in a short period of time causes SSD performance to suffer as SSD throughput (e.g., I/O throughput) is reduced while SSD latency is increased.

In an SSD device, if unused data (e.g., unused blocks) is not erased in time, the SSD device will eventually reach a point at which a previously written block needs to be erased every time a new block needs to be written. Thus, such erase-and-write operations can cause the performance of the SSD device to drop drastically, especially when a large number of new blocks need to be written in a short amount of time. An SSD device with a lot of unallocated space can perform better because such SSD device may always have blocks available for new blocks to be written, providing comfortable breathing room to reduce the effects of such erase-and-write operations. However, SSD devices with a lot of unallocated space can be very expensive. Less expensive SSD devices with less unallocated space have performance issues because previously written and unused blocks are not erased in time for the new blocks to be written.

Two methods are typically used by a file system to send trim commands (e.g., commands that identify unused blocks to the SSD device). A first method is referred to as a file system mount method. When the file system mount method is used, one or more trim commands are sent synchronously by the file system as a file is deleted, where the trim commands notifies and identifies all unused blocks that make up the file to the SSD device at once (i.e., sending the trim commands for all unused blocks of the file and deleting the file occur synchronously). Thus, when a large file (e.g., a virtual drive such as but not limited to, a vDisk) is deleted, trim commands need to be sent to the SSD device. Sending a large amount of trim commands can slow down the performance of the SSD device as discussed. Thus, the file system mount method can cause degradation of the performance of the SSD device every time a file (especially a large file) is deleted.

A second method corresponds to scheduling trim requests that are initiated when the system is idle as determined by a system administrator. Based on historic access pattern, trim commands are sent to an SSD device when the SSD device is expected to be idle (little or no I/O operations). Scheduling the trim commands when the memory system is idle is challenging for memory systems that are always busy or have unpredictable usage patterns. Typically, such trim requests correspond to sending trim commands for all unused blocks of the entire SSD device within a very short period of time, thus significantly impacting SSD performance in the manner described.

### SUMMARY

In accordance with at least some aspects of the present disclosure, a method for issuing continuous trim commands for a memory system includes periodically sending trim commands to an electronically erasable memory device. Each of the trim commands identifies unused blocks of a portion of a total storage capacity of the electronically erasable memory device for the electronically erasable memory device which can be safely erased.

In accordance with at least some aspects of the present disclosure, a system for issuing continuous trim commands for a memory system includes at least a file system. The file system is operatively coupled to an electronically erasable memory device. The file system is configured to periodically send trim commands to the electronically erasable memory device. Each of the trim commands identifies unused blocks of a portion of a total storage capacity of the electronically erasable memory device for the electronically erasable memory device to erase.

In accordance with at least some aspects of the present disclosure, a non-transitory computer readable media includes computer-executable instructions embodied thereon that, when executed by a processor, cause the processor to periodically send trim commands to an electronically erasable memory device. Each of the trim commands identifies unused blocks of a portion of a total storage capacity of the electronically erasable memory device for the electronically erasable memory device can safely erase.

The foregoing summary is illustrative only and is not intended to be in any way limiting. In addition to the illustrative aspects, implementations, and features described above, further aspects, implementations, and features will become apparent by reference to the following drawings and the detailed description.

### BRIEF DESCRIPTION OF THE DRAWINGS

FIG. 1 is a block diagram of a system for issuing continuous trim commands for a memory system, in accordance with some implementations of the present disclosure.

FIG. 2 is a flowchart outlining operations for a method for issuing continuous trim commands for a memory system, in accordance with some implementations of the present disclosure.

FIG. 3 is a flowchart outlining operations for a method for issuing continuous trim commands for a memory system, in accordance with some implementations of the present disclosure.

FIG. 4 is a flowchart outlining operations for a method for issuing continuous trim commands for a memory system, in accordance with some implementations of the present disclosure.

The foregoing and other features of the present disclosure will become apparent from the following description and appended claims, taken in conjunction with the accompanying drawings. Understanding that these drawings depict only several implementations in accordance with the disclosure and are, therefore, not to be considered limiting of its scope, the disclosure will be described with additional specificity and detail through use of the accompanying drawings.

### DETAILED DESCRIPTION

In the following detailed description, reference is made to the accompanying drawings, which form a part hereof In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and make part of this disclosure.

Implementations described herein relate to systems, methods, and non-transitory computer-readable medium for issuing continuous trim commands to an electronically erasable memory device. As used herein, an “electronically erasable memory device” refers to any memory device that erases previously stored data in a physical storage location before writing new data to the physical storage location. In some arrangements, the electronically erasable memory device can be a flash memory system such as but not limited to, an SSD device. Other examples of the electronically erasable memory device include but are not limited to, an Electrically Erasable Programmable Read-Only Memory (EEPROM), a Non-Volatile Dual In-Line Memory Module (NVDIMM), a Non-Volatile Memory Express (NVMe) device, or and the like. While SSD devices are used as examples, the arrangements described herein can be implemented on all types of electronically erasable memory devices that need existing, unused data to be erased from physical addresses before writing new data to those physical addresses.

In some arrangements, trim commands are continuously and periodically sent to an electronically erasable memory device (e.g., to a controller thereof) to cause the electronically erasable memory device to erase a small number of blocks periodically. Thus, instead of sending a trim command to the electronically erasable memory device responsive to determining that the file corresponding to the unused data is no longer in use, trim commands corresponding to small portions of the unused data are continuously and periodically issued to the electronically erasable memory device over time, so that the electronically erasable memory device can perform the erase function with respect to smaller portions of the unused data overtime instead of receiving the trim command for the entire portion of the unused data all at once. Given that only a small portion (e.g., a few blocks) of unused data is identified to the electronically erasable memory device every time, the impact of the erase to the electronically erasable memory device is minimized at any given time. Furthermore, given that the electronically erasable memory device is regularly (e.g., continuously and periodically) erased, all unused blocks can be erased over time. As such, the disclosed arrangements correspond to a cost-effective method to erase unused data with minimal impact on performance.

As used herein, “trim command” refers to a command sent by a file system to an electronically erasable memory device (e.g., to a controller of the electronically erasable memory device) to identify one or more blocks currently written on the electronically erasable memory device which can safely be erased. As used herein, a “block” refers to a unit of data that can be erased by the electronically erasable memory device. While blocks typically refer to SSD devices, one of ordinary skill in the art can appreciate that blocks can be used to refer to any unit of data that can be erased by any type of electronically erasable memory devices.

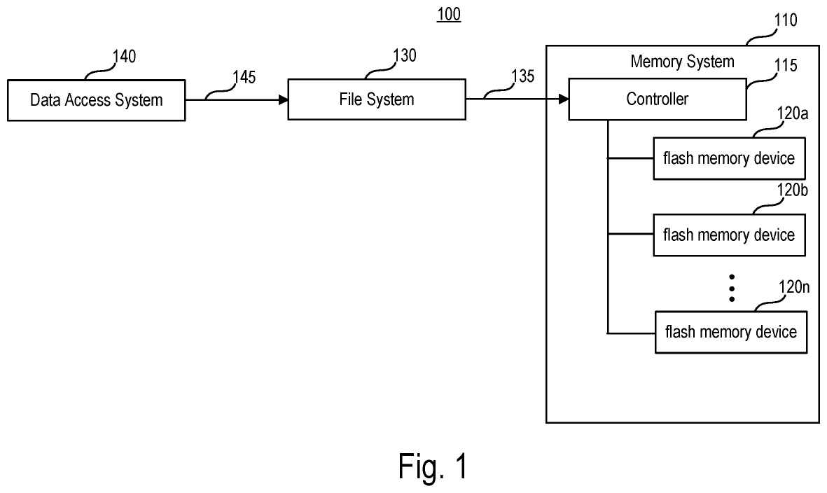

Referring now to FIG. 1, a block diagram of a system 100 for issuing continuous trim commands 135 to a memory system 110, in accordance with some implementations of the present disclosure. The memory system 110 is an electronically erasable memory device (e.g., a flash memory device) that erases previously stored data in a physical storage location before writing new data to the physical storage location. Examples of the memory system 110 include but are not limited to, an SSD device, an EEPROM, an NVDIMM, an NVMe device, or and the like. The system 100 can be any suitable computing system that uses the memory system 110 (e.g., the electronically erasable memory device) for storage capabilities. Examples of the system 100 include but are not limited to, a desktop computer, a laptop computer, a workstation computer, a mobile communication device, a smart phone, a tablet device, a server, a mainframe, an eBook reader, a Personal Digital Assistant (PDA), and the like.

As shown, the memory system 110, such as an SSD device, includes a controller 115 and flash memory devices 120a-120n. The memory system 110 uses the flash memory devices 120a-120n to store data. For example, each of the flash memory devices 120a-120n is a non-volatile memory device such as but not limited to, NAND flash memory, NOR flash memory, and the like. One of ordinary skill in the art can appreciate that while the flash memory devices 120a-120n may be particularly relevant to an SSD device, the flash memory devices 120a-120n are used herein to represent one or more memory device units each having blocks that need to be erased before writing new data to those blocks. While the flash memory devices 120a-120n are shown and described, one of ordinary skill in the art can appreciate that the memory system 110 may have any number of flash memory devices.

The controller 115 can combine raw data storage in the flash memory devices 120a-120n such that those flash memory devices 120a-120n function like a single disk drive. The controller 115 can include microcontrollers, buffers, error correction functionality, flash translation layer (FTL), and flash memory interface modules for implementing such functions. In that regard, the memory system 110 can be referred to as a “disk” or a “drive.” As described, the controller 115 includes suitable processing and memory capabilities for executing functions described herein. As described, the controller 115 manages various features for the flash memory devices 120a-120n including, but not limited to, I/O handling, reading, writing, erasing, monitoring, logging, error handling, garbage collection, wear leveling, logical to physical address mapping and the like.

In some examples, responsive to receiving a trim command (e.g., the trim commands 135) from the file system 130, the controller 115 erases blocks identified in the trim command by resetting flash cells or storage cells corresponding to the identified blocks as empty by releasing electrons stored in those flash cells.

The system 100 includes a file system 130 operatively coupled to the memory system 110 (e.g., to the controller 115). The file system 130 can refer to one or more file systems of the system 100. Although one memory system (e.g., the memory system 110) is shown to be operatively coupled to the file system 130, one of ordinary skill in the art can appreciate that two or more memory systems (each of which can be a memory system such as but not limited to, the memory system 110) can be operatively coupled to the file system 130. The file system 130 is part of an Operating System (OS) that controls a manner in which data is stored in the memory system 110. In that regard, the file system 130 serves as the interface between the memory system 110 (e.g., hardware) and a data access system 140 (e.g., software). In that regard, the file system 130 provides access to the memory system 110 to allow erasing, trimming, or cleaning unused blocks from the memory system 110 (e.g., the flash memory devices 120a-120n). In some examples, responsive to a file (e.g., a vDisk file, a database commit log, or the like) being deleted, the file system 130 can identify logical addresses of the unused blocks corresponding to the deleted file, and the controller 115 can determine the physical addresses of the unused blocks via a mapping between the logical addresses and the physical addresses of the unused blocks of the flash memory device 120a via Logical Block Address (LBA) managed by the controller 115. In some arrangements, the file system 130 is optimized for the operations of the memory system 110. Examples of the file system 130 include but are not limited to, an ext4 file system. The file system 130 can be implemented with a suitable processing circuit having a processor and memory.

The file system 130 is configured to issue or send the trim commands 135 to the memory system 110 (e.g., to the controller 115) in the manner described. The trim commands 135 each identifies blocks (e.g., logical addresses thereof) of the flash memory devices 120a-120n that needs to be erased or otherwise cleaned.

The data access system 140 corresponds to a data access layer that is on top of the file system 130. The data access system 140 is configured to issue or send trim requests 145 to the file system 130 in some arrangements. The data access system 140 can generate each of the trim requests 145 to identify a portion (e.g., a number of blocks) of the total storage capacity of the memory system 110 (e.g., of all the flash memory devices 120a-120n). For example, a trim request (corresponding to a portion of the total storage capacity) issued by the data access system 140 can identify a starting block that defines a start of that portion and a number of blocks that defines a length of the portion.

As such, the blocks identified by the data access system 140 as specified in each of the trim requests 145 include both blocks storing data that is in-use and blocks storing unused data. Responsive to receiving a trim request, the file system 130 identifies the unused blocks within all blocks specified by the trim request based on the mapping, and sends a trim command to the memory system 110 (e.g., to the controller 115) to erase or otherwise clean the unused blocks.

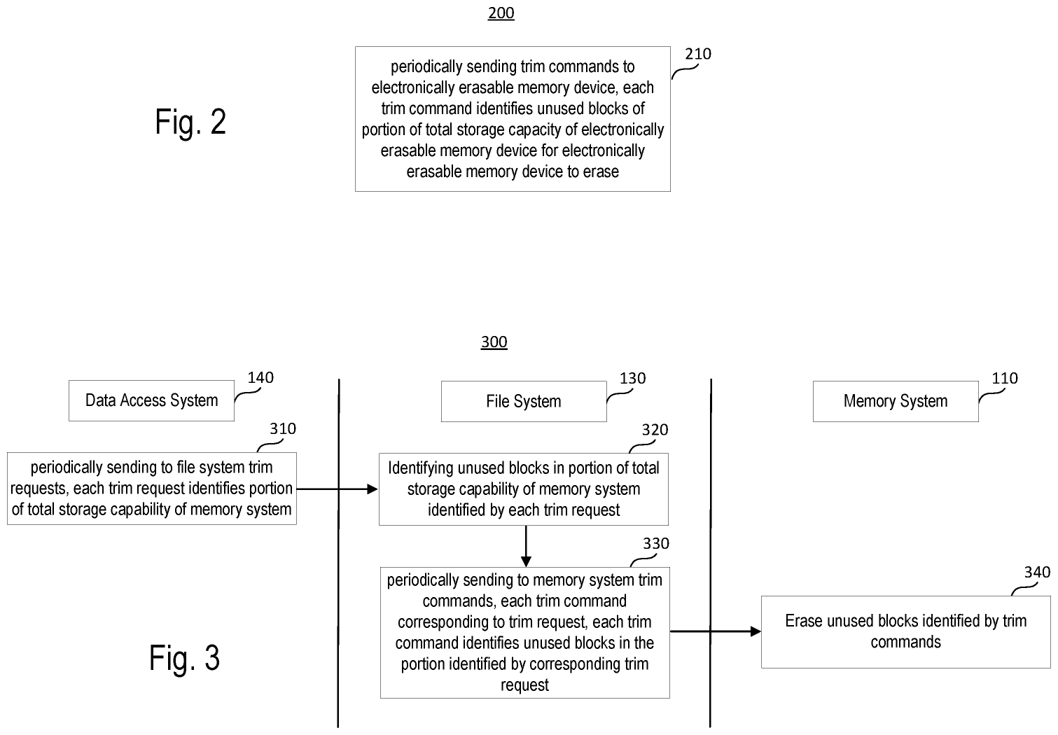

FIG. 2 is a flowchart outlining operations for a method 200 for issuing the continuous trim commands 135 (FIG. 1) for the memory system 110 (FIG. 1), in accordance with some implementations of the present disclosure. Referring to FIGS. 1-2, at 210, the trim commands 135 are periodically sent by the file system 130 to the memory system 110 (e.g., an electronically erasable memory device). Each of the trim commands 135 identifies unused blocks of a portion of a total storage capacity of the memory system 110 for the memory system 110 (e.g., the controller 115) to erase. The total storage capacity is defined by all blocks of the flash memory devices 120a-120n that can store data.

The method 200 can minimize the impact of block clean up in the memory system 110 to improve I/O data throughput and latency. The method 200 can minimize the impact of block clean up by continuously and periodically sending the trim commands 135 for the memory system 110 (e.g., the controller 115) to process, where each of the trim commands 135 identify a small number of blocks to be erased or cleaned. By portioning the erase task of the memory system 110 in a piece-meal fashion and issue the trim commands 135 continuously and periodically, the erase task of the memory system 110 is reduced at any given moment, allowing the memory system 110 to even out the erase task.

FIG. 3 is a flowchart outlining operations for a method 300 for issuing the continuous trim commands 135 for the memory system 110, in accordance with some implementations of the present disclosure. Referring to FIGS. 1-3, the method 300 is an example implementation of the method 200 (e.g., 210). At 310, the data access system 140 is configured to periodically send to the file system 130 the trim requests 145. Each of the trim requests 145 identifies a portion (e.g., blocks) of the total storage capability of the memory system 110. The total storage capability of the memory system 110 corresponds to flash cells of the memory system 110 (e.g., of the flash memory devices 120a-120n) that are not held in reserve by the controller 115 of the memory system 110. Each portion of the total storage capability corresponds to at least one of the flash cells of the memory system 110. Each of the trim requests 145 identifies the portion of the total storage capacity by identifying a starting block that defines a start of the portion and a number of blocks that defines a length of the portion.

In some examples, the size of the portion of the total storage capability (e.g., a number of blocks) designated in each of the trim requests 145 can be set based on the total storage capability of the memory system 110 (e.g., the total storage capability of the flash memory devices 120a-120n), the time allocated to erase all unused blocks in the memory system 110 once, and the frequency or periodicity of the trim requests 145. For example, the total storage capability may be a known value. The total storage capability of the memory system 110 may be cleaned a predetermined number of times (e.g., 4-6 times) per day (e.g., per 24 hours) to ensure that empty blocks are available to store new data. The frequency or periodicity of the trim requests 145 can be appropriately set at a predetermined frequency (e.g., every 1 second, 2 seconds, anywhere between 0-2 seconds, exclusively) to assume that the memory system 110 is not congested with excessive trim commands at any given time.

In some arrangements, the size of the portion of the total storage capability is determined by dividing the total storage capability by a number of trim requests 145 expected to be sent to the file system 130 to clean the total storage capability once within a cleaning period. The number of trim requests 145 expected to be sent to the file system 130 to clean the total storage capability once within a cleaning period is also a predetermined number of portions making up the total storage capability. In that regard, all portions of the total storage capability are equal.

In an example in which the memory system 110 has a total storage capability (e.g., total usable space) of 2 terabytes, the trim requests 145 may be sent every 2 seconds, and the total storage capability of the memory system 110 is to be cleaned 6 times a day (e.g., 4-hour cleaning period to clean the entirety of the memory system 110 once). In this example, 7200 trim requests 145 or 7200 portions are expected to be executed to clean the entirety of the memory system 110 once, resulting in each of the trim requests 145 identifying 278 megabytes of blocks. Other suitable methods for partitioning the total storage capability can be likewise implemented.

At 320, the file system 130 identifies unused blocks in the portion of the total storage capacity of the memory system 110 responsive to receiving each of the trim requests 145. As described, each of the trim requests 145 identifies a portion of the total storage capacity of the memory system 110. The file system 130 can identify unused blocks within each portion. Each time a file is no long in use, the file system 130 can identify (e.g., mark or tag) blocks corresponding to the unused file as unused or freed blocks. The file system 130 may not issue a trim command immediately responsive to determining that the file is no longer in use. Instead, the issuing of the trim commands 135 is triggered by the trim requests 145 in the manner described.

At 330, the file system 130 periodically sends to the memory system 110 (e.g., to the controller 115) the trim commands 135. Each of the trim commands 135 corresponds to one of the trim requests 145 received from the data access system 140. Each of the trim commands 135 identifies unused blocks in the portion identified in a corresponding one of the trim requests 145. Each of the trim commands 135 identifies unused blocks for the memory system 110 (e.g., the controller 115) to erase. In some examples, the file system 130 (e.g., a EXT4 file system) keeps track of unused blocks for which the trim commands 135 had already been sent to the memory system 110. The file system 130 send a new trim command for an unused block responsive to determining that the unused block in question is now freed and that a trim command corresponding to the unused block has not been previously sent. In some examples, for the file system 130 (e.g., a EXT4 file system), the list of blocks corresponding to which the trim commands 135 had been sent is blank each time the file system 130 is mounted (e.g. when the host is rebooted).

At 340, the memory system 110 (e.g., the controller 115) erases the unused blocks identified in each of the trim commands 135 at some point in time, whether immediately responsive to each of the trim commands or later.

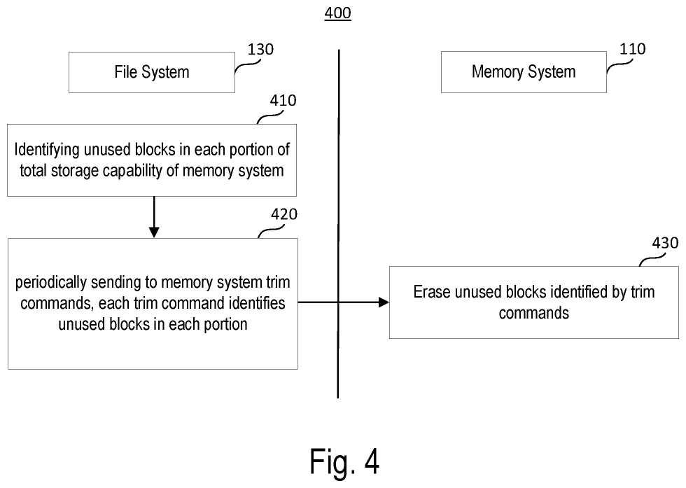

FIG. 4 is a flowchart outlining operations for a method 400 for issuing the continuous trim commands 135 for the memory system 110, in accordance with some implementations of the present disclosure. Referring to FIGS. 1-4, the method 400 is an example implementation of the method 200 (e.g., 210). The method 400 does not involve the data access system 145. For example, the portions (each identified by a starting block that defines a start of the portion and a number of blocks that defines a length of the portion) of the memory system 110 can be predetermined in the manner described and stored in any suitable memory of the file system 130.

At 410, the file system 130 identifies unused blocks in each portion of the total storage capacity of the memory system 110. Each time a file is no long in use, the file system 130 can identify (e.g., mark or tag) blocks corresponding to the unused file as unused or freed blocks. The file system 130 may not immediately issue a trim command responsive to determining that the file is no longer in use. Instead, the issuing of the trim commands 135 is triggered periodically in the manner described.

At 420, the file system 130 periodically sends to the memory system 110 (e.g., to the controller 115) the trim commands 135. Each of the trim commands 135 identifies unused blocks in one of the portions. Each of the trim commands 135 identifies the unused blocks for the memory system 110 (e.g., the controller 115) to erase.

At 430, the memory system 110 (e.g., the controller 115) erases the unused blocks identified in each of the trim commands 135 responsive to receiving each of the trim commands 135.

The various illustrative logical blocks, modules, circuits, and algorithm steps described in connection with the examples disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The hardware used to implement the various illustrative logics, logical blocks, modules, and circuits described in connection with the examples disclosed herein may be implemented or performed with a general purpose processor, a DSP, an ASIC, an FPGA or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In some exemplary examples, the functions described may be implemented in hardware, software, firmware, or any combination thereof. If implemented in software, the functions may be stored as one or more instructions or code on a non-transitory computer-readable storage medium or non-transitory processor-readable storage medium. The steps of a method or algorithm disclosed herein may be embodied in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, unless otherwise noted, the use of the words “approximate,” “about,” “around,” “substantially,” etc., mean plus or minus ten percent.

The foregoing description of illustrative implementations has been presented for purposes of illustration and of description. It is not intended to be exhaustive or limiting with respect to the precise form disclosed, and modifications and variations are possible in light of the above teachings or may be acquired from practice of the disclosed implementations. It is intended that the scope of the invention be defined by the claims appended hereto and their equivalents.

1. A method comprising:
receiving, by a file system associated with a memory system, a trim request, wherein the trim request identifies a portion of a total storage capacity of the memory system from which to erase data;
determining, by the file system, an unused block of the memory system in the portion of the total storage capacity indicated in the trim request;
periodically sending, by the file system, a trim command to the memory system to erase the data from the unused block of the memory system.

2. The method of claim 1, wherein for each instance of the trim request received, the file system sends one instance of the trim command to the memory system.

3. The method of claim 1, wherein the trim command identifies the unused block to the memory system from which the data is to be erased.

4. The method of claim 1, wherein the trim request identifies the portion of the total storage capacity by identifying a starting block of the memory system that defines a start of the portion and a number of blocks that defines a length of the portion.

5. The method of claim 1, wherein the portion of the total storage capacity comprises the unused block as well as at least one in-use block.

6. (canceled)

7. The method of claim 1, wherein
the total storage capacity is divided into a predetermined number of portions; and
the trim request identifies one of the predetermined number of portions.

8. The method of claim 7, wherein the portions are equal portions.

9. The method of claim 1, wherein an instance of the trim command is sent to the memory system every predetermined number of seconds.

10. The method of claim 1, wherein an instance of the trim command is sent to the memory system every 1 second.

11. The method of claim 1, wherein an instance of the trim command is sent to the memory system every 2 seconds.

12. The method of claim 1, wherein the memory system is a Solid State Drive (SSD) device.

13. The method of claim 1, wherein
the total storage capacity of the memory system corresponds to a plurality of flash cells; and
the portion of the total storage capacity corresponds to at least one of the plurality of flash cells.

14. A system comprising:
a file system
operatively coupled to a memory system, wherein the file system comprises programmed instructions to:
receive a trim request from a data access system, the trim request identifying a portion of a total storage capacity of the memory system from which to erase data;
determine an unused block of the memory system in the portion of the total storage capacity indicated in the trim request and
send a trim command to the memory system to erase the data from the unused block of the memory system.

15. The system of claim 14, wherein for each instance of the trim request received from the data access system, the file system sends one instance of the trim command to the memory system.

16. The system of claim 14, the trim command identifies the unused block to the memory system from which the data is to be erased.

17. The system of claim 14, wherein the trim request identifies the portion of the total storage capacity by identifying a starting block of the memory system that defines a start of the portion and a number of blocks that defines a length of the portion.

18. The system of claim 16, wherein the portion of the total storage capacity comprises the unused block as well as at least one in-use block.

19. (canceled)

20. A non-transitory computer readable media comprises computer-executable instructions embodied thereon that, when executed by a processor, cause the processor to:
receive a trim request identifying a portion of a total storage capacity of a memory system from which to erase data;
determine an unused block of the memory system in the portion of the total storage capacity indicated in the trim request and
send a trim command to the memory system to erase the data from the unused block of the memory system.

21. The non-transitory computer readable media of claim 20, wherein the portion of the total storage capacity comprises the unused block and at least one in-use block.

22. The non-transitory computer readable media of claim 20, wherein for each instance of the trim request received, the processor sends one instance of the trim command.

23. The non-transitory computer readable media of claim 20, wherein the trim command is sent immediately after receiving the trim request and determining the unused block.

24. The non-transitory computer readable media of claim 20, wherein the trim command is sent periodically.

25. The system of claim 14, wherein the trim command is sent immediately after receiving the trim request and determining the unused block.

26. The system of claim 14, wherein the trim command is sent periodically.

27. The method of claim 1, wherein the trim command is sent after receiving the trim request and determining the unused block without waiting for a system idle state.
